(19) United States
(12) Patent Application Publication
(10) Pub. No.: US 2018/0343828 A1
(43) Pub. Date: Dec. 6, 2018

(54) APPARATUS FOR FEEDING AN ANIMAL

(71) Applicant: HERD FEEDER LLC, Milton, WI (US)

(72) Inventor: Craig Lunaas, Milton, WI (US)

(21) Appl. No.: 15/996,923

(22) Filed: Jun. 4, 2018

Related U.S. Application Data
(60) Provisional application No. 62/515,289, filed on Jun. 5, 2017.

(51) Int. Cl. A01K 5/02

(52) U.S. Cl. CPC A01K 5/0225

(57) ABSTRACT

A feeder for animals. The feeder includes a housing with a front side, a back side opposite the front side, and two lateral sides. The front side, the back side, and the two lateral sides define an interior of the housing. The feeder also includes an open region positioned beneath the interior of the housing. The open region is partially defined by the two lateral sides. The feeder further includes a feed distribution member that defines a base of the interior of the housing and includes a plurality of openings. The feed distribution member is at least partially positioned in the open region. The feed distribution member is configured to retain and provide animals access to feed for animal consumption.

### CROSS REFERENCE TO RELATED APPLICATIONS

This application claims priority to U.S. Provisional Patent Application No. 62/515,289, filed Jun. 5, 2017, and entitled Apparatus for Feeding an Animal, the contents of which are herein incorporated by reference in its entirety.

### FIELD OF THE INVENTION

The present disclosure relates to an apparatus configured to feed an animal. More specifically, the disclosure relates to a gravity fed feeder for one or more animals.

### SUMMARY

Grazing animals such as horses, cows, goats, or the like typically feed on hay or other suitable foods. The food is often distributed in bulk to supply the animals for a long period of time. However, oftentimes the bulk supply is distributed from an unsanitary surface. In addition, supplying food in bulk contributes to the amount of food waste that occurs.

In one embodiment, the invention provides a feeder for animals. The feeder includes a housing with a front side, a back side opposite the front side, and two lateral sides. The front side, the back side, and the two lateral sides define an interior of the housing. The feeder also includes an open region positioned beneath the interior of the housing. The open region is partially defined by the two lateral sides. The feeder further includes a feed distribution member that defines a base of the interior of the housing and includes a plurality of openings. The feed distribution member is at least partially positioned in the open region. The feed distribution member is configured to retain and provide animal access to feed for animal consumption.

In another embodiment, the invention provides a feeder for animals. The feeder includes a housing having a front side, a back side, and two lateral sides. The front side, back side, and lateral sides together define an interior of the housing. A feed distribution member is in operable communication with the interior of the housing. The feed distribution member is in non-contact relationship with the surface upon which the housing is positioned. The feeder also includes an access port positioned between the two lateral sides on the front side of the housing. The access port provides animal access to the feed distribution member opening on the front side. The feeder further includes an open region defined by the two lateral sides and the access port. The feed distribution member is at least partially positioned in the open region and configured to hold feed for animal consumption.

In yet another embodiment, the invention provides a feeder for feeding animals. The feeder includes a housing having a front side, a back side opposite the front side, and two lateral sides. The front side, back side, and two lateral sides together define an interior of the housing. The feeder also a feed distribution member in operable communication with the interior of the housing. The feed distribution member is coupled to the housing and in a non-contact relationship with a surface upon which the housing is positioned. The feeder further includes an access port positioned between the two lateral sides on the front side of the housing. The access port providing animal access to the feed distribution member. The feeder also includes an open region defined by the two lateral sides and the access port. The feed distribution member is at least partially positioned in the open region and is configured to hold feed for animal consumption.

Other aspects of the invention will become apparent by consideration of the detailed description and accompanying drawings.

### BRIEF DESCRIPTION OF THE DRAWINGS

FIG. 1 is a perspective view of a feeder containing feed in the form of hay.

FIG. 2 is an elevation view of a front of the feeder of FIG. 1.

FIG. 3 is a perspective view of the back of the feeder of FIG. 1.

FIG. 4 is a close-up view of an animal safe latch for use with the feeder of FIG. 1.

FIG. 5 is an elevation view of the feeder of FIG. 1 with a pair of doors open and a shelf in an upright position.

FIG. 6 is a close up view of the shelf of FIG. 5 illustrating a latch.

FIG. 7 is an elevation view of the feeder of FIG. 5 with the shelf in a loading position.

FIG. 8 is an elevation view of a feed distribution member in the feeder of FIG. 1.

FIG. 9 is a perspective view of an animal eating from the feeder of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

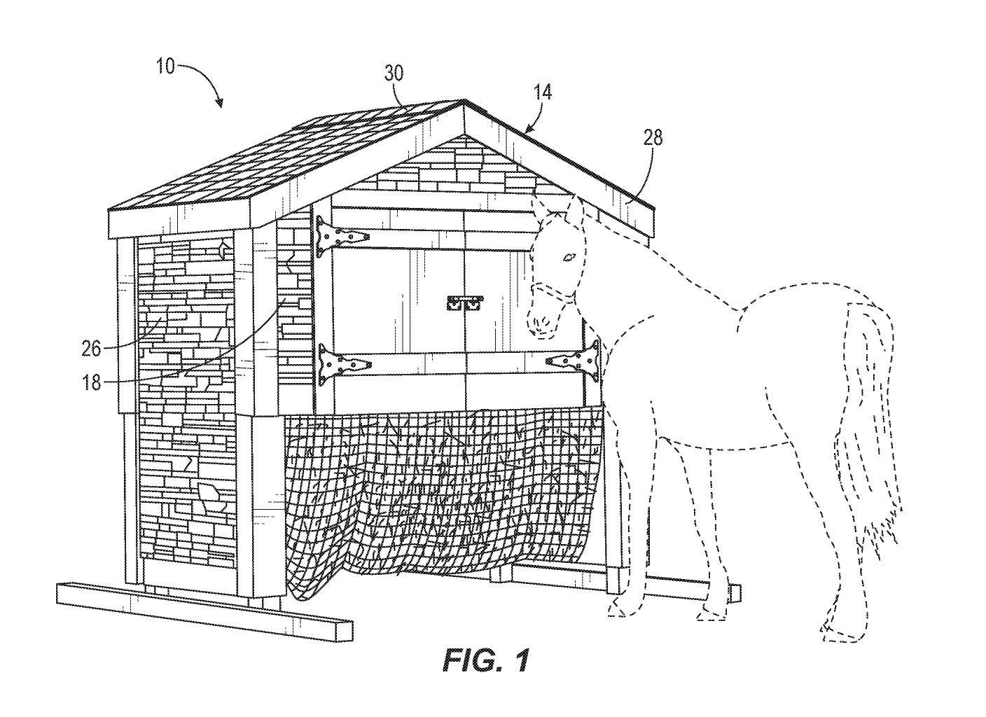

FIGS. 1-9 illustrate a feeder 10 for feeding animals. The feeder 10 is configured to receive, store, and distribute animal feed to one or more animals. The feeder 10 advantageously reduces feed waste by suspending the feed off the ground, providing an animal access to feed while minimizing feed contact with the ground. This in turn reduces contact with water, animal excrement, and other contaminants on the ground that results in feed waste.

In the illustrated embodiments, the feed is illustrated as hay or straw. It should be appreciated that hay is used for purposes of illustration, and feed can also include any suitable food (or food stuff) consumed by one or more animals (e.g., oats, carrots, hay, a mixture of one or more foods, etc.). In addition, while the figures illustrate the feeder 10 being used by a horse, it should be appreciated that the horse is shown for purposes of illustration. The feeder 10 can be used to distribute feed to any suitable animal. Accordingly, an animal can include, but is not limited to, a horse, a cow, a goat, a donkey, deer, any domesticated animal, any non-domesticated animal, or any other suitable animal.

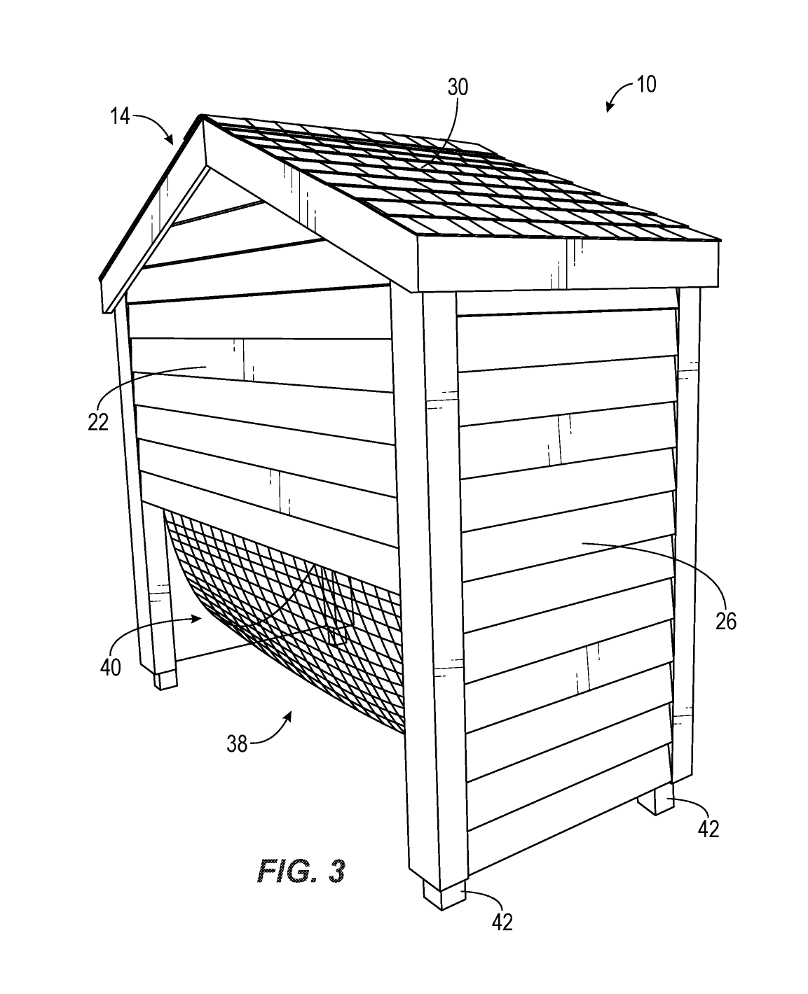

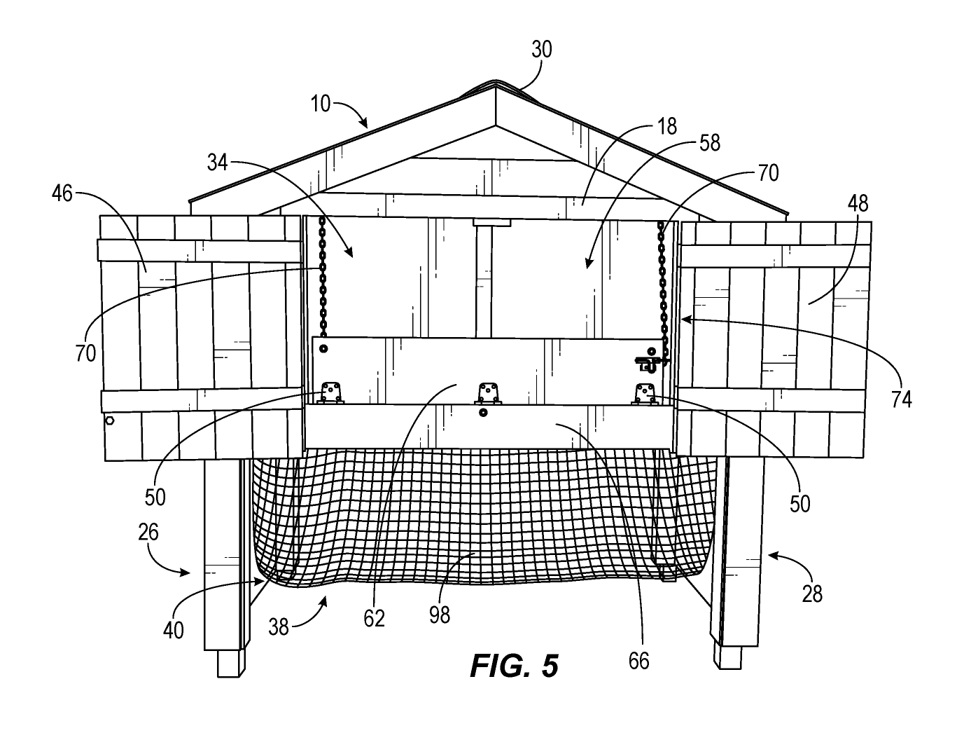

With reference to FIG. 1, the feeder 10 includes a housing 14 with a front side 18, a back side 22 (shown in FIG. 3) opposite the front side 18, and two lateral sides 26, 28. A roof 30 is supported on the housing 14 to enclose an interior 34 (shown in FIG. 5) of the housing 14. The two lateral sides 26, 28 extend further downward from the roof 30 than the front and back sides 18, 22 to contact the ground. In the illustrated embodiment, the housing 14 is made of a wood material. For example, the wood material can be cedar, or any other wood or wood-like material. In other embodiments, the housing 14 can be made of a stone material such as concrete, granite, or the like. In further embodiments, the housing may be made out of a combination of wood, stone, metal, plastic, a composite, or any other suitable materials.

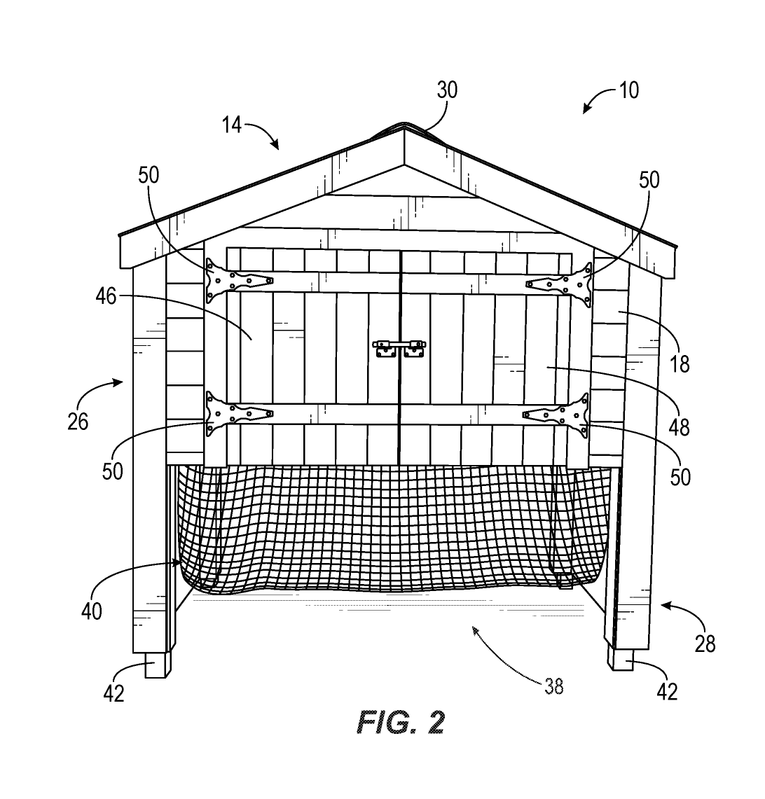

Now referring to FIG. 2, an open region 38 is partially defined by the two lateral sides 26, 28 and at least one access port 40. In the illustrated embodiment, the feeder 10 includes two access ports 40, (one beneath the front side 18 and one beneath the back side 22), extending between the lateral sides 26, 28. Each access port 40 acts as a portal for one or more animals to access the food stored in and distributed by the feeder 10. In other embodiments, the feeder 10 can include one access port 40 or three or more access ports 40. For example, an embodiment of the feeder 10 with one access port 40 can be used in applications where the feeder 10 is positioned against a wall, barn, or other structure. The housing 14 further includes feet 42 that support the feeder 10 on a surface such as the ground. A pair of doors 46, 48 is coupled to the front side 18 of the housing 14 with hinges 50. While a plurality of doors 46, 48 are illustrated, in other embodiments the feeder 10 can include a single door 46.

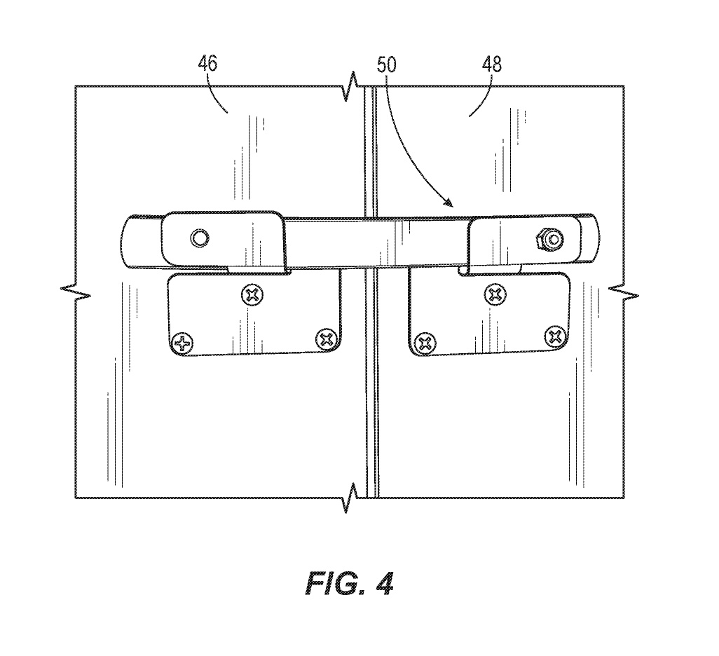

With reference to FIG. 4, an animal safe latch 54 is configured to secure the doors 46, 48 in a closed configuration. The animal safe latch 54 extends minimally away from the doors 46, 48 to form a low profile. In addition, the animal safe latch 54 includes rounded and/or curved edges. This minimizes (or eliminates) sharp or pointed edges to prevent animals from clipping or cutting their noses, mouths, or other areas when feeding from (or moving around) the feeder 10. The animal safe latch 54 is configured to lock and unlock (or latch and unlatch) the doors 46, 48. While FIG. 4 illustrates the latch 54 in a locked orientation, in an unlocked orientation the doors 46, 48 can be opened to access a loading opening 58 that leads to the interior 34 of the housing 14 (shown in FIG. 5).

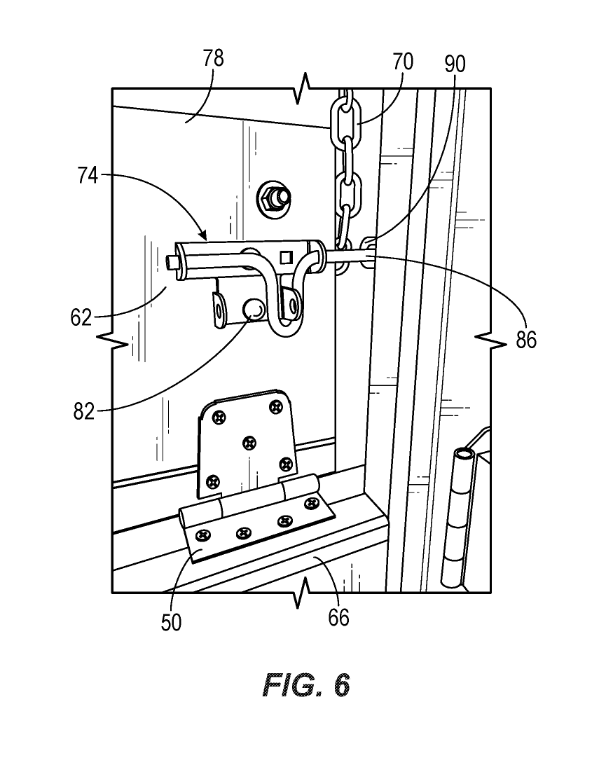

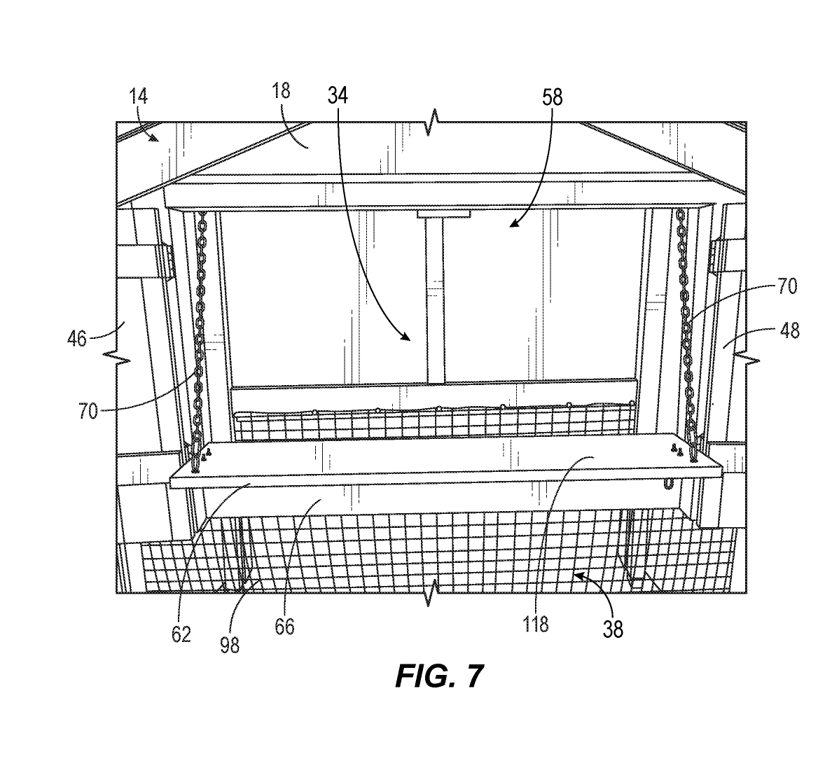

With reference to FIGS. 5-7, a shelf 62 is coupled to a lower support 66 inside the interior 34 of the housing 14. As shown in FIGS. 5-6, the shelf 62 is coupled to the lower support 66 with a plurality of hinges 50. The hinges 50 allow the shelf 62 to pivot between an upright position (shown in FIG. 5) and a load position (shown in FIG. 7). With reference now to FIG. 7, in the load position, the shelf 62 can provide a surface to assist with the loading feed into the feeder 10 (e.g., to position and prepare feed, etc.). As a non-limiting example, one or more bales of hay (or other feed) can be balanced on the shelf 62 to allow for the removal of binding material (e.g., twine, wire, etc.) that binds a bale of hay. Once removed, the hay can then be loaded into the interior 34. Fasteners 70 (illustrated as chains 70) are coupled at one end to the shelf 62, and coupled at the opposing end to the interior 38 of the housing 14. The chains 70 restrict the shelf 62 from extending too far (e.g., past a horizontal plane, etc.) when pivoting from the upright position to the load position. While the illustrated embodiment depicts the fastener 70 as a chain 70, in other embodiments the fastener 70 can be formed of rope, flexible linkage, gas spring, or any other elongated member suitable for limiting a pivot distance of the shelf 62. Referring now to FIG. 6, a latch assembly 74 (or latch 74) is secured to the shelf 62 with fasteners 82 (e.g., screws, nails, bolts, etc.). The latch 74 is illustrated as coupled to a bottom side 78 of the shelf 62. However, in other embodiments, the latch 74 can be coupled to, or otherwise engage, any suitable portion of the shelf 62. The latch 74 is configured to slide longitudinally between an unlock position (where the shelf 62 is free to move from the upright position to the loading position) and a lock position (where an end 86 of the latch 74 slides into a loop 90 (or recess 90) to secure the shelf 62 in the upright position. In other embodiments, the latch 74 can be secured to a portion of the housing 14, while the loop 90 can be secured to a portion of the shelf 62.

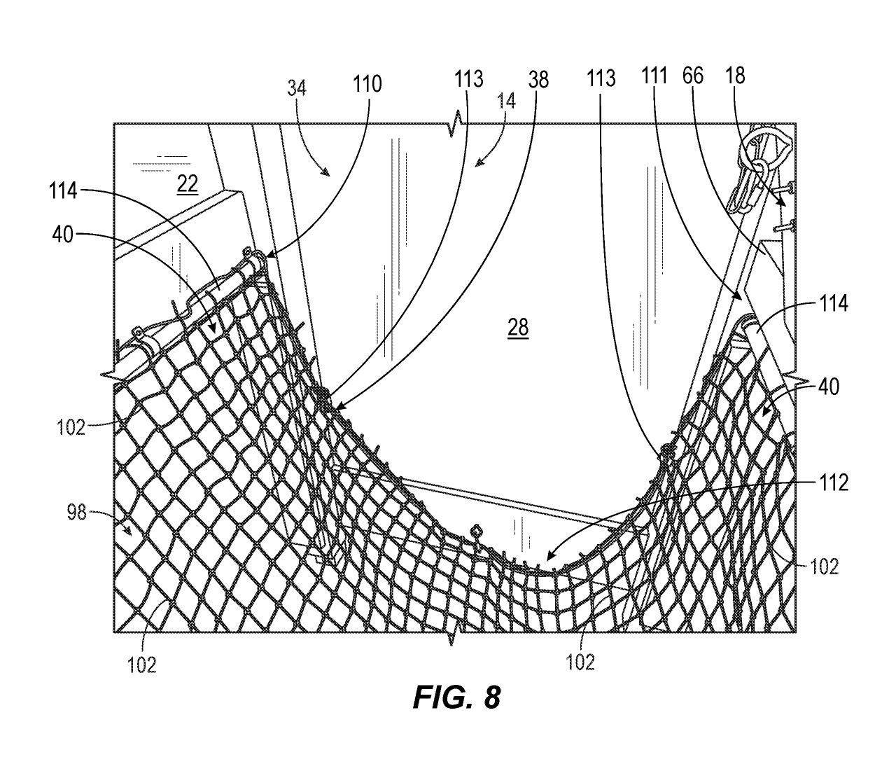

Referring now to FIG. 8, the interior 34 of the housing 14 includes a feed distribution member 98 (illustrated as a net 98) that defines a base of the interior 34. The feed distribution member 98 extends further downward from the roof 30 than the front and back sides 18, 22 and is at least partially positioned in the open region 38. The feed distribution member 98 is accessible by an animal through the access ports 40. In the illustrated embodiment, the feed distribution member 98 is made from a soft, yet strong material that will not damage the lips, gums, teeth, or other sensitive body parts of animals while they feed. In other embodiments, the material of the feed distribution member 98 can be made from any other material or combination of materials (e.g., nylon, etc.). The feed distribution member 98 can include a plurality of openings 102 (or feed access apertures 102) that allow an animal to access the feed stored in the interior 34 of the housing 14. Opposing sides 110, 111 of the feed distribution member 98 are coupled to the interior 34 of the housing 14 on both the front side 18 and the back side 22, respectively. Opposing ends 112 of the feed distribution member 98 are similarly coupled to the lateral sides 26, 28 of the housing 14, respectively, by clips 113. It should be appreciated that FIG. 8 illustrates one end 112 of the feed distribution member, with the opposite end 112 being substantially the same (or a mirror image). In the illustrated embodiment, support members 114 engage a portion of the feed distribution member 98 on each side 110, 111, and are fastened to the housing 14. For example, in the illustrated embodiment, pipes 114 are respectively weaved through the outer most openings 102 on each side 110, 111 of the feed distribution member 98 and fastened to the interior 34 of the housing 14. In other embodiments, the feed distribution member 98 can be secured directly to the interior 34 of the housing 14 with fasteners 82, be integrally formed with the housing 14, or coupled to the housing 14 in any suitable or desired manner. The feed distribution member 98 drapes from the front side 18 of the housing 14 to the back side 22 of the housing 14 forming a U-shaped cross section there between that extends (or hangs) in the open region 38. The feed distribution member 98 is in a non-contact relationship with the ground (or other surface the housing 14 is positioned on). Stated another way, the feed distribution member 98 does not contact the ground, or is spaced a distance away from the ground. In the illustrated embodiment, the front and back sides 18, 22 extend further downward from the roof 30 than the feed distribution member 98.

In one or more examples of embodiments, the feeder 10 can include a mat (not shown). The mat can be positioned underneath the feed distribution member 98 in the open region 38 to catch hay (or other feed) that falls out of the feed distribution member 98 while an animal is feeding. The mat can be made of plastic, rubber, or any other suitable material. The mat can allow for recovery of feed. For example, the user can occasionally pick up the mat (or pick up the feed on the mat) and return the feed to the feeder 10 through the loading opening 58. This advantageously limits feed waste.

To load the feeder 10 with feed (such as hay), a user unlatches the animal safe latch 54 and opens at least one (or both) of the doors 46, 48 to access the loading opening 58. The user can then pivot the shelf 62 from the upright position (shown in FIG. 5) to the loading position (shown in FIG. 7). For example, the user can slides the latch 70 from the lock position to the unlock position allowing the user to pivot the shelf 62 from the upright position to the loading position. When in the loading position, the shelf 62 exposes a surface 118 (or top surface 118) (shown in FIG. 7) for a user to position and prepare feed (e.g., bales of hay, etc.) for loading into the feeder 10. The height of the shelf 62 from the ground can be similar to the height of a pickup truck bed. This allows the user to laterally transfer bales of hay (or other feed) from the pickup truck bed to the shelf 62. After the bales of hay are prepared (e.g., binding material removed, etc.), the user can push the hay off the shelf 62 and into the open region 38. In the illustrated embodiment, the feeder 10 can store one or more bales of hay, up to and including twelve bales of hay. In other embodiments, the feeder 10 can be sized to store anywhere from one bale of hay to fifteen or more bales of hay. Once the feeder 10 is loaded (or reloaded) with feed, the user can transition from the shelf 62 from the loading position to the upright position, lock the shelf 62 into the upright position, and then close and latch the doors 46, 48.

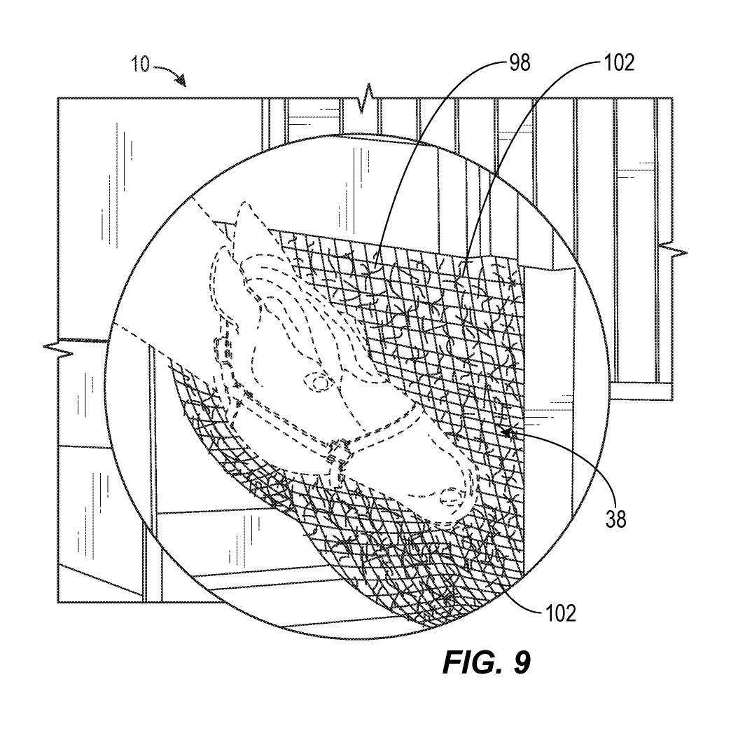

With the feeder 10 loaded with feed and the animal safe latch 54 in a latched configuration, animals can feed from the feeder 10 by removing (or pulling) feed from one or more of the plurality of openings 102 in the feed distribution member 98, as shown in FIG. 9. As feed in the feed distribution member 98 is pulled or otherwise removed, feed from the interior 34 backfills into the feed distribution member 98 to take the place of the removed feed. Stated another way, the feed is selectively distributed from the interior 34 to the feed distribution member 98 through a gravity (or gravity feed) arrangement.

The feeder 10 described herein provides certain advantages over known feeders in the art. For example, because the feed distribution member 98 holds the feed above the ground (e.g., the feed distribution member 98 is spaced a distance away from the surface on which the feeder is positioned on), animals withdraw feed they intend to eat from the feed distribution member 98. This minimizes waste caused by feed piled on the ground that is exposed to water, animal excrement, or other contaminants. The gravity feed arrangement also allows for feed to backfill into the feed distribution member 98, providing a continuous distribution of feed. In addition, the capacity of the feeder 10 allows for improved control of animal nutrition by avoiding long periods of time without feed in their stomachs. The capacity of the feeder 10 can also allow a user to systematically replenish the feed in the feeder 10 based on a predetermined schedule (e.g., daily, weekly, etc.), as the feeder 10 can be sized to contain more feed than can be consumed in a short period of time.

What is claimed is:

1. A feeder for feeding animals, the feeder comprising:
a housing including a front side, a back side opposite the front side, and two lateral sides, the front side, the back side, and the two lateral sides defining an interior of the housing;
an open region positioned beneath the interior of the housing, the open region partially defined by the two lateral sides; and
a feed distribution member defining a base of the interior of the housing and including a plurality of openings, the feed distribution member at least partially positioned in the open region, the feed distribution member configured to retain and provide animal access to feed for animal consumption.

2. The feeder of claim 1, further comprising an opening on the front side of the housing that is in communication with the interior of the housing.

3. The feeder of claim 2, further comprising a door on the front side of the housing that selectively provides access to the interior of the housing through the opening.

4. The feeder of claim 3, wherein the door includes an animal safe latch that selectively locks and unlocks the door, the animal safe latch having a low profile that extends minimally away from the door.

5. The feeder of claim 4, wherein the animal safe latch includes rounded, non-sharp and non-pointed edges.

6. The feeder of claim 2, further comprising a shelf positioned in the opening, the shelf movable from a first position, in which the shelf is upright, and a second position, in which the shelf provides a top surface that feed can be positioned and prepared for loading into the interior of the housing.

7. The feeder of claim 1, further comprising an access port positioned between the two lateral sides, the feed distribution member being animal accessible through the access port.

8. The feeder of claim 1, wherein the feed distribution member forms a U-shaped cross section between the front and back side of the housing in the open region.

9. The feeder of claim 1, wherein the feed distribution member is spaced a distance away from the surface on which the feeder is positioned on.

10. The feeder of claim 1, wherein the feed distribution member is a net.

11. A feeder for animals, the feeder comprising:
a housing having a front side, a back side, and two lateral sides, the sides together define an interior of the housing;
a feed distribution member in communication with the interior of the housing, such that feed loaded into the interior of the housing travels to the feed distribution member where it can be accessed by an animal for consumption; and
an opening on the front side, the opening configured to be enclosed by a door to selectively provide access to the interior of the housing, such as to load or reload the interior of the housing with feed.

12. The feeder of claim 11, wherein the feed distribution member includes a plurality of openings, the plurality of openings provide animal access to the feed.

13. The feeder of claim 11, further comprising a shelf positioned in the opening, the shelf movable from a first position, in which the shelf is upright, and a second position, in which the shelf provides a top surface that feed can be positioned and prepared for loading into the interior of the housing.

14. The feeder of claim 11, further comprising an open region defined by the two lateral sides and an access port, the access port allowing an animal access to feed stored in the feed distribution member.

15. The feeder of claim 14, wherein the feed distribution member defines a base of the interior of the housing.

16. The feeder of claim 15, wherein the feed distribution member at least partially extends into the open region.

17. The feeder of claim 16, wherein the feed distribution member forms a U-shaped cross section between the front and back side of the housing in the open region.

18. The feeder of claim 11, wherein the feed distribution member is positioned above a surface on which the feeder is positioned.

19. A feeder for feeding animals, the feeder comprising:
a housing having a front side, a back side opposite the front side, and two lateral sides, the front side, back side, and lateral sides together define an interior of the housing;
a feed distribution member in operable communication with the interior of the housing, the feed distribution member coupled to the housing and in a non-contact relationship with a surface upon which the housing is positioned;
an access port positioned between the two lateral sides on the front side of the housing, the access port providing animal access to the feed distribution member;
an open region defined by the two lateral sides and the access port, the feed distribution member at least partially positioned in the open region and configured to hold feed for animal consumption.

20. The feeder of claim 19, wherein feed stored in the interior of the housing is gravity fed into the feed distribution member.
